(19) United States
(12) Patent Application Publication
(10) Pub. No.: US 2026/0128346 A1
(43) Pub. Date: May 7, 2026

(54) APPARATUS AND METHOD FOR MANUFACTURING SECONDARY BATTERY

(71) Applicant: SK ON CO., LTD., Seoul (KR)

(72) Inventors: Seung Won CHOI, Daejeon (KR); Hak Bong MUN, Daejeon (KR); Jae Gyu BYUN, Daejeon (KR); Moon Hyung JUNG, Daejeon (KR)

(21) Appl. No.: 19/377,047

(22) Filed: Nov. 3, 2025

(30) Foreign Application Priority Data
Nov. 5, 2024 (KR) 10-2024-0155013

(51) Int. Cl. H01M 10/04; H01M 50/119

(52) U.S. Cl. CPC H01M 10/0404; H01M 10/049; H01M 50/119

(57) ABSTRACT

An apparatus for manufacturing a secondary battery according to various embodiments of the present disclosure may include a mold unit configured to apply a first pressing force in a first direction to a forming region of a battery case, and to apply a second pressing force in a second direction opposite to the first direction to the forming region that has been deformed by the first pressing force.

### CROSS-REFERENCE TO RELATED APPLICATION

This patent application claims the priority and benefits of Korean patent application No. 10-2024-0155013, filed on November 05, 2024, the disclosure of which is incorporated herein by reference in its entirety.

### BACKGROUND

### 1. Field of the Invention

The present disclosure relates to an apparatus and a method for manufacturing a secondary battery.

### 2. Description of the Related Art

Various types of secondary batteries are used as energy sources in electric vehicles or electronic devices. In the secondary batteries, a jelly-roll-type electrode assembly, in which an anode plate, a cathode plate and a separator are wound together, is used, or alternatively, an electrode assembly fabricated by stacking an anode plate, a cathode plate and a separator in an appropriate order may be used.

This electrode assembly is accommodated in a battery housing and connected to an anode terminal and a cathode terminal. The housing is then sealed after being filled with an electrolyte.

### SUMMARY

An object of the present disclosure is to provide an apparatus and a method for manufacturing a secondary battery that can minimize damage to the battery case during the manufacturing process of the secondary battery.

An apparatus for manufacturing a secondary battery according to various embodiments of the present disclosure may include a mold unit configured to apply a first pressing force in a first direction to a forming region of a battery case, and to apply a second pressing force in a second direction opposite to the first direction to the forming region that has been deformed by the first pressing force.

In exemplary embodiments, the first direction may be a direction away from a central axis of the battery case.

In exemplary embodiments, the second pressing force may be smaller than the first pressing force.

In exemplary embodiments, the forming region may be formed axially above an electrode assembly accommodated inside the battery case.

In exemplary embodiments, the forming region may include a region of a side wall of the battery case where a beading part is formed.

In exemplary embodiments, the forming region may be deformed to protrude radially outward of the battery case by the first pressing force, and the forming region may be deformed to be recessed radially inward of the battery case by the second pressing force.

In exemplary embodiments, the mold unit may rotate to apply the first pressing force or the second pressing force.

In exemplary embodiments, the mold unit may apply the first pressing force while at least a portion thereof is accommodated inside the battery case.

In exemplary embodiments, the apparatus may further include a control unit configured to control the position of the mold unit, wherein the control unit may control the mold unit to move from a first position for applying the first pressing force to the side wall of the battery case to a second position for applying the second pressing force to the side wall of the battery case.

In exemplary embodiments, the mold unit may include a first mold unit configured to apply the first pressing force and a second mold unit configured to apply the second pressing force.

In exemplary embodiments, the apparatus may further include a backup roller disposed on a side of the battery case opposite to the mold unit, wherein the backup roller may be disposed to support at least one of an upper region or a lower region of the forming region.

In exemplary embodiments, the apparatus may further include: a first rotation jig configured to support one side of an outer surface of the battery case while the first pressing force is applied, thereby rotating the battery case; and a second rotation jig configured to support one side of an inner surface of the battery case while the second pressing force is applied, thereby rotating the battery case.

An apparatus for manufacturing a secondary battery configured to form a beading part in a battery case of the secondary battery according to various embodiments of the present disclosure may include: a first mold, at least a portion of which is disposed inside the battery case and configured to press a forming region of a side wall of the battery case to deform it so as to protrude radially outward; and a second mold configured to press the forming region, which has been deformed to protrude radially outward by the first mold, so as to be recessed radially inward, wherein the direction of the pressing force applied by the first mold is opposite to the direction of the pressing force applied by the second mold.

A method for manufacturing a secondary battery according to various embodiments of the present disclosure may include: a first forming step of applying a first pressing force in a first direction to a forming region of a battery case; and a second forming step of applying a second pressing force in a second direction opposite to the first direction to the forming region that has been deformed by the first pressing force.

In exemplary embodiments, the first direction may be a direction away from a central axis of the battery case.

In exemplary embodiments, the second pressing force may be smaller than the first pressing force.

In exemplary embodiments, the forming region may be formed axially above an electrode assembly accommodated inside the battery case.

In exemplary embodiments, in the first forming step, the forming region may be deformed to protrude radially outward of the battery case by the first pressing force, and in the second forming step, the forming region may be deformed to be recessed radially inward of the battery case by the second pressing force.

In exemplary embodiments, the method may further include, after completion of the first forming step, a mold unit moving step of moving a mold unit that has performed the first forming step to a position for performing the second forming step.

In exemplary embodiments, the second forming step may be performed after deformation of at least a portion of the forming region has begun.

The apparatus and method for manufacturing a secondary battery according to various embodiments of the present disclosure may minimize the pressing force applied to the side wall of the battery case during the formation of the final beading part by first applying a pressing force in a direction opposite to the pressing direction for forming the final beading part.

In addition, it is possible to minimize damage to the outer circumferential surface of the side wall (e.g., damage to a plating layer) that may occur during formation of the beading part.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a schematic cross-sectional view of a secondary battery that can be manufactured using an apparatus and a method for manufacturing a secondary battery according to an exemplary embodiment of the present disclosure;

FIGS. 2 and 3 are schematic views for describing an apparatus and a method for manufacturing a secondary battery according to an exemplary embodiment of the present disclosure;

FIGS. 4 and 5 are schematic views for describing an apparatus and a method for manufacturing a secondary battery according to another exemplary embodiment of the present disclosure;

FIG. 6 is a flowchart illustrating a method for manufacturing a secondary battery according to an exemplary embodiment of the present disclosure; and

FIG. 7 is a flowchart illustrating a method for manufacturing a secondary battery according to another exemplary embodiment of the present disclosure.

### DETAILED DESCRIPTION OF THE INVENTION

As used herein, the singular form may include the plural form unless the context clearly dictates otherwise.

In addition, when used to describe and define the present disclosure, terms such as “comprise,” “include,” “consist of,” and “have” should be interpreted in a non-exclusive manner. Unless explicitly stated otherwise, these terms should be construed to imply that the presence of the corresponding component, and not to exclude but rather include other components.

It should be understood that the accompanying drawings schematically illustrate the features of the present disclosure and may be reduced or enlarged relative to actual dimensions, and may be exaggerated or partially omitted for clarity.

The secondary battery described in the present disclosure may be any type of conventional battery cell capable of converting the chemical energy of materials stored in the battery into electrical energy, and capable of supporting multiple charge and discharge cycles.

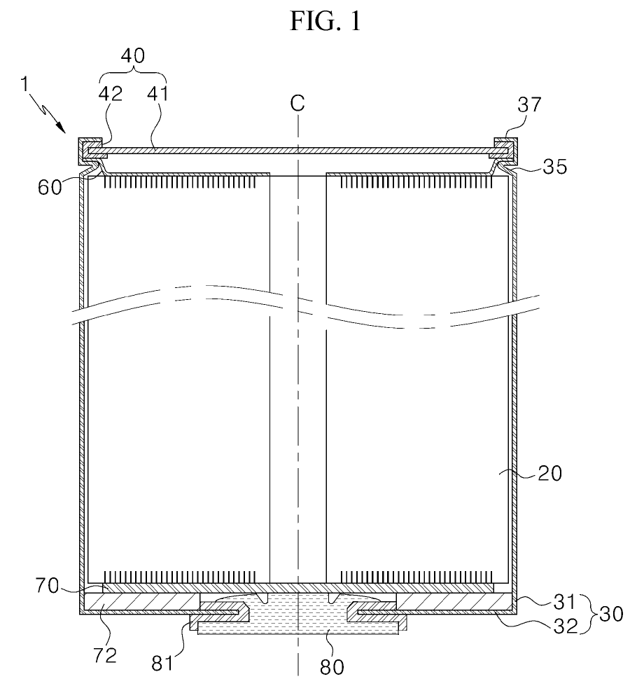

FIG. 1 is a schematic cross-sectional view of a secondary battery that can be manufactured using an apparatus and a method for manufacturing a secondary battery according to an exemplary embodiment of the present disclosure.

Referring to FIG. 1, a secondary battery 1 that can be manufactured using the apparatus and method for manufacturing a secondary battery according to various embodiments of the present disclosure may include an electrode assembly 20, a battery case 30, and a cap assembly 40.

First, the electrode assembly 20 may include a first electrode plate (not shown), a second electrode plate (not shown), and a separator (not shown). The electrode assembly 20 may be wound about a winding shaft such that the first electrode plate and the second electrode plate are not in contact with each other through the separator.

For example, the first electrode plate may be an anode plate. In an exemplary embodiment, the first electrode plate may include a first coating part on which an anode coating layer is formed on an anode current collector in the form of a metal foil, and a first uncoated part on which no anode coating layer is formed.

For example, the second electrode plate may be a cathode plate. The second electrode plate may include a second coating part on which a cathode active material is coated on a cathode current collector in the form of a metal foil, and a second uncoated part on which no cathode active material is coated on the cathode current collector.

The first uncoated part and the second uncoated part may be respectively exposed at opposite axial ends of the electrode assembly to define electrode tabs.

The separator may be interposed between the first electrode plate and the second electrode plate to prevent the first electrode plate and the second electrode plate from being electrically connected to each other and causing a short circuit.

The battery case 30 may be formed in a cylindrical shape having an internal space. For example, the battery case 30 may be open at an upper end in the axial direction. The battery case 30 may be made of a metal material and may include a plating layer for corrosion resistance. Here, the battery case 30 is illustratively described as cylindrical for ease of understanding; however, this is merely exemplary, and it should be understood that the apparatus and method for manufacturing a secondary battery according to the present disclosure may be applied to battery cases 30 of various shapes.

The battery case 30 may include a lower wall 32 and a side wall 31. The lower wall 32 may be provided in a generally disk shape and may have the electrode terminal 80 disposed thereon. The side wall 31 may be a cylindrical portion extending upward from the periphery of the lower wall 32. The electrode assembly may be inserted into the interior of the battery case 30 through the open upper end of the battery case 30.

A beading part 35 and a crimping part 37 may be formed on the side wall 31 of the battery case 30.

The electrode assembly accommodated in the battery case 30 may be fixed by the beading part 35 formed on the side wall 31 of the battery case 30.

The beading part 35 may be formed by inwardly recessing a partial region of the side wall 31 in a radial direction above the electrode assembly 20, thereby providing a portion for seating the cap assembly 40 and fixing the electrode assembly 20.

For example, the battery case 30 may be electrically connected to the first electrode plate through a first current collecting plate 60 connected to the beading part 35.

The crimping part 37 may be a portion where an upper end of the side wall 31 is bent inward to surround the cap assembly 40. The crimping part 37 may be formed by bending the upper end of the side wall 31 toward the inside of the battery case 30 while the cap assembly 40 is seated on the beading part 35. By being formed to surround the cap assembly 40, the crimping part 37 may fix the cap assembly 40 and seal the inside of the battery case 30.

After the electrode assembly and the electrolyte are inserted into the battery case 30, the cap assembly 40 may be coupled to an opening portion 51 to close the battery case 30. For example, the cap assembly 40 may be seated on the beading part 35.

The cap assembly 40 may include a cap plate 41 and a sealing gasket 42.

The cap plate 41 may have a circular plate shape to correspond to the shape of the opening portion 51. The periphery of the cap plate 41 may be surrounded by the sealing gasket 42.

For example, after the sealing gasket 42 is seated on the beading part 35, the cap plate 41 may be disposed on an upper side of the sealing gasket 42.

The sealing gasket 42 may be bent together with the opening portion 51 of the battery case 30 through a crimping process while being interposed between the cap plate 41 and the battery case 30.

An electrode terminal 80 connected to the second electrode plate may be disposed on the lower wall 32 of the battery case 30. For example, the electrode terminal 80 may be connected to the second electrode plate through a second current collecting plate 70. The second current collecting plate 70 may be insulated from the battery case 30 by an insulator 72. The electrode terminal 80 may be disposed to be insulated from the battery case 30 by an insulating gasket 81.

The structure of the secondary battery 1 described above is merely illustrative to facilitate understanding of the present disclosure, and the scope of the present disclosure is not limited to the detailed structure of the secondary battery 1.

In describing various embodiments of the present disclosure, the axial direction may refer to a direction parallel to the direction in which a central axis (e.g., C of FIG. 1) extends, along which a jelly-roll-type electrode assembly 20 is wound, and the radial direction may refer to a direction extending toward or away from the central axis.

Meanwhile, since the central axis of a cylindrical battery case 30 and the central axis of the electrode assembly 20 are coaxially aligned, the axial direction in the present disclosure may be understood as a direction parallel to the direction in which a central axis of the cylindrical battery case 30 extends, and the radial direction may be understood as a direction extending from the central axis of the cylindrical battery case 30 toward the side wall 31.

Meanwhile, during the manufacturing process of the secondary battery, the beading part 35 of the battery case 30 described above may be formed as an inward recess between the electrode assembly and the crimping part 37, thereby not only fixing the electrode assembly but also serving as a buffer to prevent an external force from being applied to the electrode assembly during the process of forming the crimping part 37.

Generally, the beading part 35 may be formed by bringing a beading mold into contact with and pressing against the side wall 31 while the battery case 30 rotates, such that the side wall 31 is recessed inward toward the center of the battery case 30. Here, as in the conventional process, the method of forming the beading part 35 by pressing the side wall 31 inward using the beading mold may be referred to as a “concave forming method.”

However, this method may cause damage to a region of the side wall 31 where the beading mold comes into contact during the process of forming the beading part 35. For example, a plating layer may be formed on the outer surface of the side wall 31 to ensure corrosion resistance, but the plating layer may be damaged by contact and pressure from the beading mold.

The apparatus and method for manufacturing a secondary battery proposed in the present disclosure may minimize damage to the side wall 31 during the process of forming the beading part 35.

In various embodiments of the present disclosure, unlike the conventional concave forming method, the beading part 35 may be formed by sequentially applying an outward pressing force and an inward pressing force to the side wall 31. This method may be referred to as a “composite forming method.”

More specifically, when forming the beading part 35 on the side wall 31, a first forming process is performed in a direction opposite to the desired forming direction (e.g., radially outward), followed by a second forming process in the desired forming direction (e.g., radially inward). As a result, the stress required for deformation of the side wall 31 to form the beading part 35 may be reduced, thereby decreasing the stress applied to the outer surface of the forming region. Accordingly, the beading part 35 may be formed into a desired shape with less stress than that of the conventional concave forming method, thereby minimizing damage to the outer surface of the side wall 31 caused by contact with the beading mold.

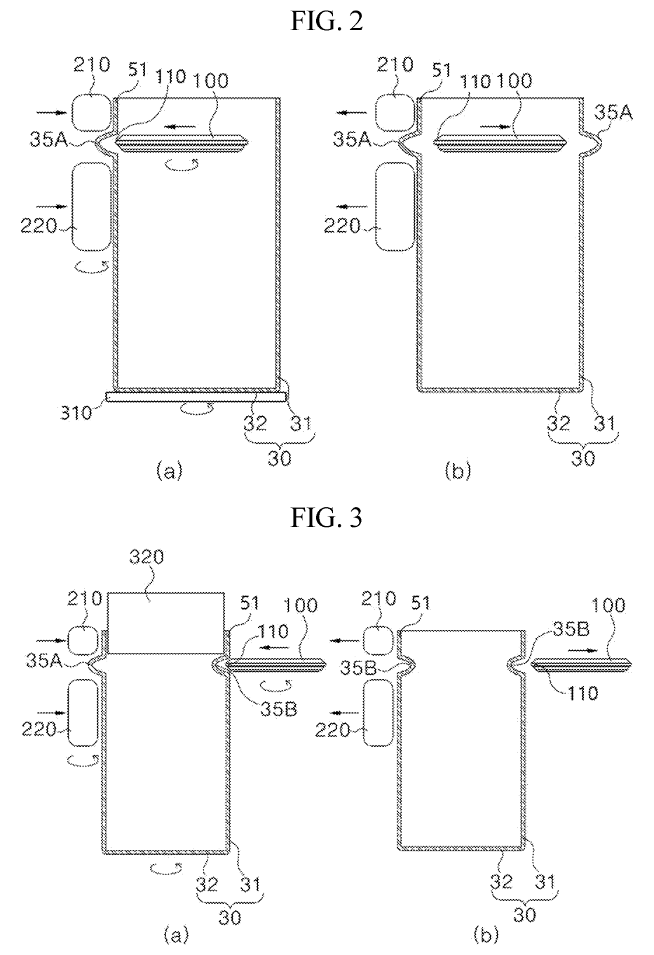

FIGS. 2 to 5 are schematic views for describing an apparatus and a method for manufacturing a secondary battery according to exemplary embodiments of the present disclosure.

### Apparatus for manufacturing a secondary battery

First, referring to FIGS. 2 to 5, the apparatus for manufacturing a secondary battery according to various embodiments of the present disclosure will be described in detail.

Referring to FIGS. 2 to 5, the apparatus for manufacturing a secondary battery according to an exemplary embodiment of the present disclosure may include a mold unit 100, a backup roller 200, and a control unit (not shown). In addition, the apparatus for manufacturing a secondary battery may further include a rotation jig 300 configured to rotate the battery case 30 during the process of forming the beading part 35.

The mold unit 100 may include a pressing surface 110 configured to come into contact with the battery case 30, thereby pressing the battery case 30, and may be configured to rotate about a rotational axis parallel to the central axis of the battery case 30.

For example, the pressing surface 110 of the mold unit 100 may have a shape corresponding to the specific shape of the beading part 35 to be formed.

The mold unit 100 may rotate about the rotational axis and apply a pressing force to the forming region of the battery case 30. The mold unit 100 may deform the forming region of the side wall 31 through rolling friction with an inner or outer circumferential surface of the side wall 31.

The forming region may refer to a portion of any one side of the battery case 30. For example, the forming region may mean a portion of the side wall 31 of the battery case 30. For example, the forming region may include a region where the beading part 35 is formed on the side wall 31 of the battery case 30. Here, the forming region may be described as an upper portion of the side wall 31 located above the electrode assembly. However, this is merely exemplary, and the forming region may be applied to any portion of the battery case 30 that requires deformation, for example, a portion of the lower wall 32 of the battery case 30.

For example, the mold unit 100 may apply a first pressing force in a first direction to the forming region of the battery case 30.

The first direction may refer to a direction opposite to the desired final forming direction. For example, the first direction may refer to a radially outward direction away from the central axis of the battery case 30. However, this is not limited thereto. For example, when the desired final forming direction is radially outward, the first direction may refer to a radially inward direction toward the central axis of the battery case 30.

The first pressing force may be a deformation force that generates internal stress within the forming region in a direction opposite to the desired final forming direction.

In addition, the mold unit 100 may provide a second pressing force in a second direction opposite to the first direction to the forming region of the battery case 30. For example, the mold unit 100 may provide a second pressing force in the second direction opposite to the first direction to the forming region that has been deformed by the first pressing force.

The second direction may be the desired final forming direction. For example, the second direction may refer to a radially inward direction toward the central axis of the battery case 30. However, this is not limited thereto. For example, when the first direction refers to a radially inward direction, the second direction may refer to a radially outward direction, which is opposite thereto.

The second pressing force may be a deformation force for deforming the forming region in the desired final forming direction. For example, in the present disclosure, the second pressing force may be smaller than the first pressing force described above, but is not limited thereto.

For example, the mold unit 100 may be disposed inside the battery case 30. In the first forming step, with at least a portion of the mold unit 100 accommodated within the battery case 30, the pressing surface 110 may be brought into contact with the inner circumferential surface of the side wall 31 to apply the first pressing force. In the first forming step, the mold unit 100 may be disposed at a first position inside the battery case 30.

For example, the mold unit 100 may be disposed outside the battery case 30. In the second forming step, the mold unit 100 may be disposed at a second position outside the battery case 30.

The control unit may control the mold unit 100 such that the pressing force applied to the forming region is adjusted. The control unit may also control the timing at which the mold unit 100 applies the pressing force to the forming region.

The positional movement of the mold unit 100 may be controlled by the control unit. For example, the mold unit 100 may be moved from a first position to a second position to sequentially perform the first forming step and the second forming step.

In an exemplary embodiment, the mold unit 100 may include a first mold unit 100a and a second mold unit 100b.

The first mold unit 100a may be disposed at a first position inside the battery case 30 to perform the first forming step. The second mold unit 100b may be disposed at a second position outside the battery case 30 to perform the second forming step.

For example, the first mold unit 100a and the second mold unit 100b may be arranged side by side with respect to the central axis of the battery case 30 when viewed from above, but the arrangement is not limited thereto.

In an exemplary embodiment, the forming region of the battery case 30 may be deformed to protrude radially outward of the battery case 30 by the first pressing force, and the forming region may be deformed to be recessed radially inward of the battery case 30 by the second pressing force.

The backup roller 200 may be disposed on a side of the side wall 31 of the battery case opposite to the mold unit 100. The backup roller 200 may support the side wall 31 in a direction opposite to the pressing force applied by the mold unit 100, thereby preventing unnecessary deformation of the side wall 31.

For example, the backup roller 200 may be disposed to support at least one of an upper region or a lower region of the region (e.g., the forming region) where the first or second pressing force is applied to the side wall 31 of the battery case 30.

For example, in the first forming step, since the forming region of the side wall 31 is deformed to protrude radially outward, the backup roller 200 may support the side wall 31 so as not to interfere with a first formed part 35A, which protrudes radially outward from the side wall 31.

For example, the backup roller 200 may include an interference-preventing groove (not shown) to prevent interference with the first formed part 35A while being disposed adjacent to the outer circumferential surface of the side wall 31 and supporting upper and lower portions of the forming region.

In an exemplary embodiment, the backup roller 200 may be disposed to support the upper and lower regions of the region (e.g., the forming region) where the first pressing force or the second pressing force is applied to the side wall 31 of the battery case 30, respectively.

For example, as shown in FIGS. 2 to 4, the backup roller 200 may include a first backup roller 210 disposed to support an upper region of the forming region of the side wall 31 of the battery case 30, and a second backup roller 220 disposed to support a lower region of the forming region.

The control unit may be configured to control the pressing force, the timing of pressing, and/or the position of the mold unit 100.

For example, the control unit may control the second pressing force applied in the second forming step (S930) to be smaller than the first pressing force applied in the first forming step (S910). As described above, in the present disclosure, because of the internal stress remaining in the first formed part 35A formed during the first forming step (S910), the beading part 35 may be processed even with a smaller pressing force in the second forming step (S930). Therefore, in the present disclosure, even if the control unit controls the second pressing force to be smaller than the first pressing force, the required deformation corresponding to the desired shape of the beading part 35 may be achieved.

In addition, the control unit may be configured to control the position of the backup roller 200 according to the position of the mold unit 100.

For example, as shown in FIGS. 2 and 3, when performing the first forming step (S910) and the second forming step (S930) using a single mold unit 100, the control unit may move the mold unit 100 from a first position, at which a first pressing force is applied in the first forming step (S910), to a second position, at which a second pressing force is applied.

In addition, the control unit may control the timing of applying the pressing force of the mold unit 100. The control unit may control the mold unit 100 such that the application of the second pressing force by the second mold unit 100b begins after the application of the first pressing force by the first mold unit 100a has begun.

The rotation jig 300 may include a first rotation jig 310 and a second rotation jig 320.

The first rotation jig 310 may be disposed to rotate the battery case 30 during the first forming step. For example, the first rotation jig 310 may be disposed outside the battery case 30. For example, the first rotation jig 310 may support one side of the outer surface of the battery case 30 to rotate the battery case 30.

In the first forming step of the present disclosure, since the mold unit 100 is disposed inside the battery case 30, the first rotation jig 310 for rotating the battery case 30 supports one side of the outer surface of the battery case 30. However, this is not limited thereto, and the first rotation jig 310 may be disposed to support and rotate one side of the inner surface of the battery case 30 at a location that does not interfere with the mold unit 100.

The second rotation jig 320 may be disposed to rotate the battery case 30 during the second forming step. For example, at least a portion of the second rotation jig 320 may be disposed inside the battery case 30. For example, the second rotation jig 320 may support one side of the inner surface of the battery case 30 to rotate the battery case 30. For example, as shown in FIG. 3(a), the second rotation jig 320 may be disposed to support and rotate the open upper end of the battery case 30, but is not limited thereto.

Alternatively, the second rotation jig 320 may have the same configuration as the first rotation jig 310 described above. In this case, the first rotation jig 310 and the second rotation jig 320 may be disposed to support the battery case 30 at positions that do not interfere with the mold unit 100 during the first forming step.

### Method for manufacturing a secondary battery

Hereinafter, based on the structure of the secondary battery described above, a method for manufacturing a secondary battery using the apparatus for manufacturing a secondary battery according to various embodiments of the present disclosure will be described in detail.

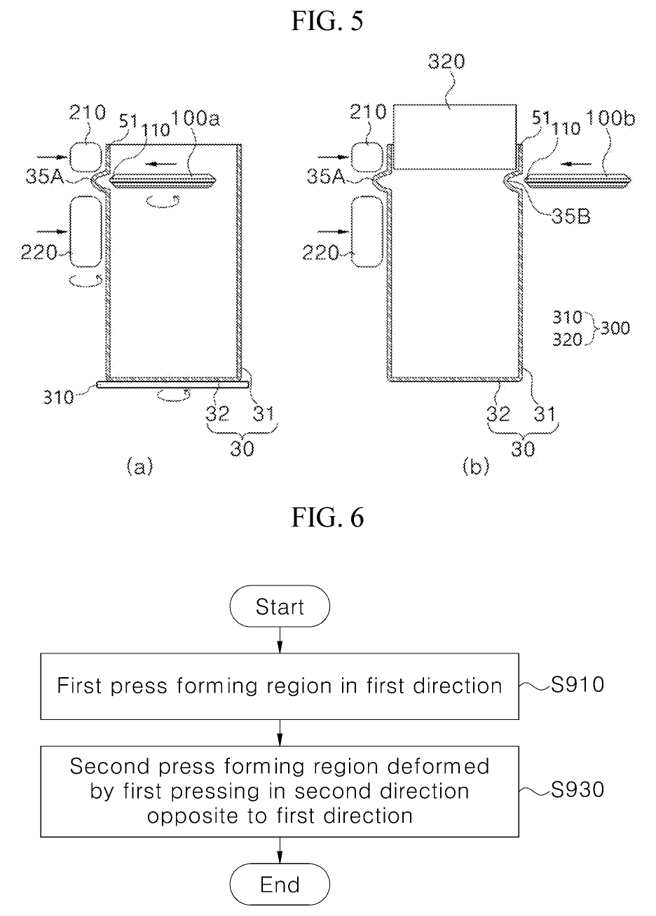

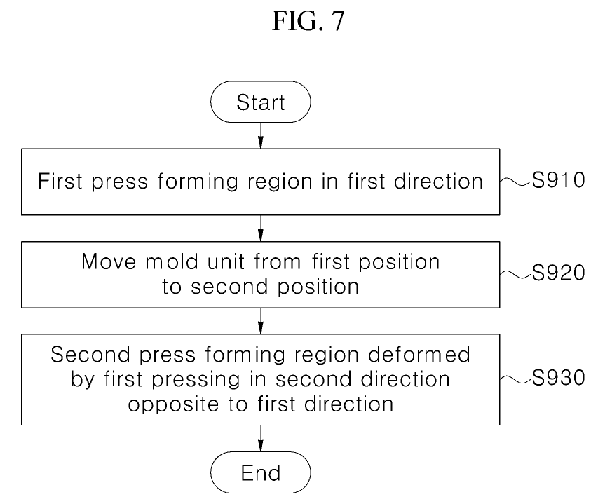

FIG. 6 is a flowchart illustrating a method for manufacturing a secondary battery according to an exemplary embodiment of the present disclosure, and FIG. 7 is a flowchart illustrating a method for manufacturing a secondary battery according to another exemplary embodiment of the present disclosure.

Referring to FIGS. 6 and 7, the method for manufacturing a secondary battery according to an exemplary embodiment of the present disclosure may include a first forming step of forming the side wall 31 of the battery case 30 in a direction opposite to the forming direction of a final beading part 35, and a second forming step of forming the side wall 31 again in the forming direction of the final beading part 35.

### First forming step (formation of residual stress

The method of manufacturing a secondary battery according to an exemplary embodiment of the present disclosure may include a first forming step. The first forming step may be a step of forming internal residual stress in the battery case 30 in a direction opposite to the forming direction of the final beading part 35 prior to forming the beading part 35 in the battery case 30.

For example, in the first forming step, the mold unit 100 may press the inner circumferential surface of the side wall 31 at a first position inside the battery case 30 to form the first formed part 35A. Here, the first position may correspond to a height of the forming region of the side wall 31 inside the battery case 30.

Referring again to FIGS. 2 and 3, the present disclosure may exemplarily describe that the first forming step and the second forming step are sequentially performed by the single mold unit 100.

Referring to FIG. 2(a), in the first forming step, the mold unit 100 may contact and press the inner circumferential surface of the side wall 31, thereby forming the first formed part 35A through rolling contact and pressure.

In the first forming step, the side wall 31 of the battery case 30 may be deformed to protrude in a direction opposite to the forming direction of the final beading part 35 (e.g., radially outward). That is, the direction of the first pressing force applied to the side wall 31 in the first forming step may be opposite to the direction of the second pressing force applied to the side wall 31 in the second forming step.

The first forming step may be performed while the battery case 30 is rotated by the first rotation jig 310.

In the first forming step, the mold unit 100 may apply a first pressing force in a radially outward direction to the inner circumferential surface of the side wall 31 of the battery case 30.

Here, the region of the side wall 31 of the battery case 30 that is pressed by the mold unit 100 may be referred to as the forming region, and in the first forming step, the inner circumferential surface of the forming region of the side wall 31 may be pressed by the mold unit 100.

In the first forming step, the forming region of the side wall 31 may be deformed to protrude radially outward by the first pressing force applied by the mold unit 100.

Through the first forming step, a first formed part 35A protruding radially outward may be formed on the side wall 31 of the battery case 30. During the deformation process caused by the first pressing force, residual stress may accumulate inside the first formed part 35A.

For example, the shape of the first formed part 35A may be identical to that of a second formed part 35B described below, except for the protrusion direction, but is not limited thereto. Here, the first formed part 35A may be described as having a convex shape.

Since the mold unit 100 is required to press the inner circumferential surface of the side wall 31 of the battery case 30 in the first forming step, the mold unit 100 may be disposed inside the battery case 30. At this time, a position where the mold unit 100 applies the first pressing force to the inner circumferential surface of the side wall 31 inside the battery case 30 may be described as a first position. For example, the first position may correspond to a height of the forming region of the side wall 31 inside the battery case 30. For example, the first position may be a position where the pressing surface 110 of the mold unit 100 is disposed adjacent to the side wall 31.

In the first forming step, the pressing surface 110 of the mold unit 100 may rotate while being in contact with the inner circumferential surface of the side wall 31, thereby allowing the side wall 31 to be deformed into a convex shape through rolling contact and pressure.

When the inner circumferential surface of the side wall 31 is pressed by the mold unit 100 in the first forming step, the outer circumferential surface of the side wall 31 may be supported by the backup roller 200. The backup roller 200 may support the side wall 31 in a direction opposite to the pressing force applied by the mold unit 100, thereby preventing unnecessary deformation of the side wall 31.

Referring to FIG. 2(b), after the first formed part 35A is formed by the mold unit 100, the control unit may move the mold unit 100 to a standby position to facilitate its withdrawal from the inside of the battery case 30. For example, the standby position may be a position adjacent to the central axis of the battery case 30.

In an exemplary embodiment, the first forming step of the present disclosure may be performed before the electrode assembly is inserted into the battery case 30. This prevents contamination of the electrode assembly by foreign substances that may be generated during the process and prevents interference between the mold unit 100 and the electrode assembly. Accordingly, in this case, the electrode assembly may be inserted after completion of the first forming step. However, the first forming step may also be performed with the electrode assembly accommodated inside the battery case 30.

Generally, in the manufacturing process of a secondary battery, the beading part 35 is formed by applying a pressing force in a radially inward direction to the side wall 31 of the battery case 30, so that the pressing direction corresponds to the direction in which the beading part 35 is recessed.

However, in the present disclosure, the first formed part 35A having a convex shape is first formed by pressing the side wall 31 in a radially outward direction, which is opposite to the conventional forming direction.

The first forming step proposed in the present disclosure is intended to utilize the Bauschinger effect so as to minimize damage to the forming region of the battery case 30 while forming the beading part 35 in the second forming step, in which the second formed part 35B is formed.

Specifically, the Bauschinger effect refers to a phenomenon in which, after a metal material has been plastically deformed in one direction, subsequent deformation in the opposite direction becomes easier when the material is subsequently deformed in the opposite direction. For example, when a metal material is deformed in tension, internal defects such as dislocations are generated and move, resulting in work hardening. In this process, residual stress remains inside the material. This residual stress affects the microstructure of the material, thereby reducing its resistance to deformation in the opposite (compressive) direction. That is, when plastic deformation is subsequently performed in the compressive direction after tensile deformation, the yield strength in the compressive direction decreases due to the interaction between the existing residual stress and dislocations, allowing the material to deform more easily in the compressive direction.

According to an exemplary embodiment of the present disclosure, in designing the beading part 35 with a desired deformation amount for the battery case 30, the internal stress remaining in the first formed part 35A, which has been deformed by applying pressure in the opposite direction, enables the second forming step for forming the final beading part 35 to achieve the required deformation amount of the beading part 35 even when a smaller pressing force than that used for forming the first formed part 35A is applied. Therefore, in the present disclosure, even when the beading part 35 is processed to have the same deformation amount, the Bauschinger effect allows the pressing force applied to the outer circumferential surface of the side wall 31 to be minimized, thereby minimizing damage to the side wall 31 (e.g., damage to the plating layer) that may occur during processing.

### Second forming step formation of beading part

The method for manufacturing a secondary battery according to various embodiments of the present disclosure may include a second forming step. The second forming step may be a step of finally forming the beading part 35 by utilizing the residual stress generated in the side wall 31 (e.g., the forming region) of the battery case 30 during the first forming step.

The second forming step may be performed after completion of the first forming step. Alternatively, the second forming step may be performed after deformation has begun in at least a portion of the battery case 30 through the first forming step.

The second forming step may be performed by applying a second pressing force in a direction opposite to the first pressing force while the internal stress due to the first pressing force remains in the forming region of the side wall 31 of the battery case 30.

In the second forming step, the mold unit 100 may apply a second pressing force in a radially inward direction to the outer circumferential surface of the side wall 31 of the battery case 30. Here, the direction in which the second pressing force is applied may be opposite to that of the first pressing force. For example, the second pressing force may be smaller than that of the first pressing force. In this regard, the second pressing force is described as being smaller than the first pressing force as an example for minimizing damage to the forming region of the battery case 30. However, the present disclosure is not limited thereto, and such damage to the forming region may alternatively be prevented by controlling the rotational speed or rotational frequency of the mold unit 100 during the second forming step.

The region where the second pressing force is applied may be at least coextensive with the region where the first pressing force is applied in the side wall 31 of the battery case 30. For example, in the second forming step, the second pressing force may be applied to the first formed part 35A, which has a convex shape formed through the first forming step.

In the second forming step, the first formed part 35A, which was deformed to protrude outwardly through the first forming step, may be deformed to be recessed radially inward through the second pressing force.

Through the second forming step, a second formed part 35B, which protrudes radially inward, may be formed on the side wall 31 of the battery case 30. The second formed part 35B may be the beading part 35 to be finally formed. Here, the second formed part 35B may be described as having a concave shape.

For example, the shape of the second formed part 35B may be identical to that of the first formed part 35A described above, except for the protruding direction, but is not limited thereto.

Since the mold unit 100 is required to press the outer circumferential surface of the side wall 31 of the battery case 30 in the second forming step, the mold unit 100 may be disposed outside the battery case 30.

At this time, a position where the mold unit 100 applies a second pressing force to the outer circumferential surface of the side wall 31 outside the battery case 30 may be described as a second position. For example, the second position may correspond to a height of the forming region of the side wall 31 outside the battery case 30. For example, the second position may be a position where the pressing surface 110 of the mold unit 100 is disposed adjacent to the outer circumferential surface of the first formed part 35A.

Referring again to FIG. 3(a), in an exemplary embodiment, the second forming step may be performed by moving the mold unit 100, which has completed processing of the first formed part 35A and is in the standby position, to a second position outside the battery case 30.

In this case, the method for manufacturing a secondary battery may further include, after completion of the first forming step, a mold unit movement step (S920) of moving the mold unit 100 that has performed the first forming step to a position for performing the second forming step.

In the second forming step, the mold unit 100 positioned at the second position may come into contact with and press the outer circumferential surface of the side wall 31, thereby forming the second formed part 35B through rolling friction.

For example, the second forming step may be performed while the battery case 30 is rotated by the second rotation jig 320.

Referring again to FIG. 3(b), in an exemplary embodiment, after the second formed part 35B is formed, the control unit may move the mold unit 100 to an end position spaced apart from the side wall 31 of the battery case 30, thereby completing the forming process of the beading part 35.

While the first and second forming steps have been described above with reference to FIGS. 2 and 3 as being performed using the single mold unit 100, this is merely exemplary, and the present disclosure is not limited thereto.

For example, the first and second forming steps may alternatively be performed sequentially by respective mold units 100.

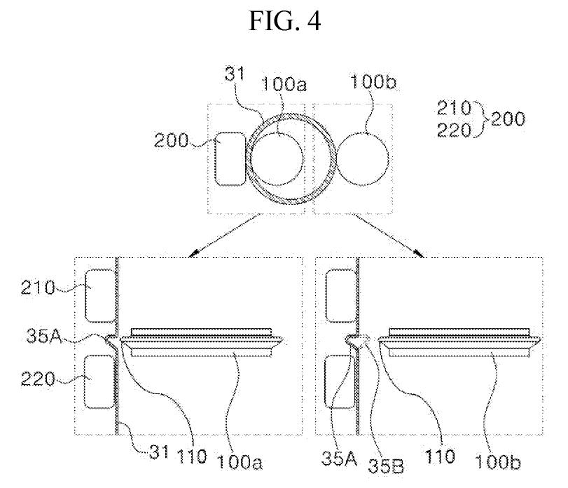

In the exemplary embodiment described with reference to FIGS. 4 and 5, the first and second forming steps are the same as those described above, except that they are performed by respective mold units 100. Therefore, a repetitive description will be omitted.

Referring again to FIGS. 4 and 5, the first forming step may be performed by the first mold unit 100a disposed at a first position inside the battery case 30. In addition, the second forming step may be performed by the second mold unit 100b disposed at a second position outside the battery case 30.

Referring to FIG. 4, the first mold unit 100a and the second mold unit 100b may be arranged side by side with respect to the central axis of the battery case 30 when viewed from above.

In this embodiment, the overall process speed may be faster than that in the previously described embodiment, because the controller does not need to move the position of the mold unit 100 to perform the second forming step after completion of the first forming step.

In an exemplary embodiment, the control unit may control the second mold unit 100b such that the second forming step begins even before completion of the first forming step by the first mold unit 100a.

For example, the second forming step may begin after deformation of at least a portion of the battery case 30 by the first pressing force has begun.

For example, the first formed part 35A may be formed by the first mold unit 100a along the periphery of the side wall 31 during a single rotation of the battery case 30. Even if the first formed part 35A has not yet been completely formed along the entire periphery when the first rotation of the battery case 30 is completed, the controller may begin to apply pressing to the first formed part 35A by the second mold unit 100b.

In this embodiment, since the process is performed using separate mold units 100, if the first formed part 35A has been formed on at least a portion of the battery case 30 by the first mold unit 100a, the controller may control the second mold unit 100b to apply a second pressing force to the already formed first formed part 35A.

For example, as shown in FIG. 4, when the first mold unit 100a and the second mold unit 100b are arranged side by side with respect to the central axis of the battery case 30 when viewed from above, after the battery case 30 begins to rotate and the first formed part 35A starts to be formed by the first mold unit 100a, the pressing operation by the second mold unit 100b may begin when the battery case 30 has rotated approximately half a turn.

Therefore, according to the present embodiment, the method for manufacturing a secondary battery may achieve a higher manufacturing speed. Alternatively, the arrangement of the first mold unit 100a and the second mold unit 100b may be changed, if necessary, to further accelerate the manufacturing speed.

As described above, the apparatus and method for manufacturing a secondary battery according to various embodiments of the present disclosure may perform the first forming step (S910) to induce deformation in the opposite direction prior to the second forming step (S930) of forming the final beading part 35, thereby minimizing the magnitude of the pressing force applied to the outer circumferential surface of the side wall 31 during formation of the beading part 35 on the side wall 31 of the battery case 30, and minimizing damage to the side wall 31, such as damage to the plating layer, that may occur during forming.

In the above, although the embodiments of the present disclosure have been described with all components combined in one or operating in combination, the present disclosure is not necessarily limited to such embodiments. Within the scope of the purpose of the present disclosure, all components may be selectively combined in one or more forms and operated accordingly. Unless otherwise defined, all terms including technical or scientific terms have the same meanings as commonly understood by those skilled in the art to which the present disclosure pertains. Commonly used terms, such as those defined in dictionaries, should be interpreted in accordance with their contextual meanings in the relevant technical field, and unless explicitly defined in the present disclosure, shall not be interpreted in an idealized or unduly formal sense.

The above description is merely illustrative of the technical spirit of the present disclosure, and it will be appreciated by those skilled in the art to which the present disclosure pertains that various modifications and variations can be made without departing from the essential characteristics of the present disclosure. Therefore, the embodiments disclosed herein are intended to describe, not to limit, the technical spirit of the present disclosure, and the scope of the technical spirit is not limited to these embodiments. The scope of protection of the present disclosure shall be defined by the following claims, and all technical spirits that fall within the equivalent scope shall be construed as being included within the scope of the present disclosure.

What is claimed is:

1. An apparatus for manufacturing a secondary battery comprising:
a mold unit configured to apply a first pressing force in a first direction to a forming region of a battery case, and to apply a second pressing force in a second direction opposite to the first direction to the forming region that has been deformed by the first pressing force.

2. The apparatus for manufacturing a secondary battery according to claim 1, wherein the first direction is a direction away from a central axis of the battery case.

3. The apparatus for manufacturing a secondary battery according to claim 1, wherein the second pressing force is smaller than the first pressing force.

4. The apparatus for manufacturing a secondary battery according to claim 1, wherein the forming region is formed axially above an electrode assembly accommodated inside the battery case.

5. The apparatus for manufacturing a secondary battery according to claim 1, wherein the forming region includes a region of a side wall of the battery case where a beading part is formed.

6. The apparatus for manufacturing a secondary battery according to claim 1, wherein the forming region is deformed to protrude radially outward of the battery case by the first pressing force, and the forming region is deformed to be recessed radially inward of the battery case by the second pressing force.

7. The apparatus for manufacturing a secondary battery according to claim 1, wherein the mold unit rotates to apply the first pressing force or the second pressing force.

8. The apparatus for manufacturing a secondary battery according to claim 1, wherein the mold unit applies the first pressing force while at least a portion thereof is accommodated inside the battery case.

9. The apparatus for manufacturing a secondary battery according to claim 1, further comprising a control unit configured to control the position of the mold unit,
wherein the control unit controls the mold unit to move from a first position for applying the first pressing force to the side wall of the battery case to a second position for applying the second pressing force to the side wall of the battery case.

10. The apparatus for manufacturing a secondary battery according to claim 1, wherein the mold unit comprises a first mold unit configured to apply the first pressing force and a second mold unit configured to apply the second pressing force.

11. The apparatus for manufacturing a secondary battery according to claim 1, further comprising a backup roller disposed on a side of the battery case opposite to the mold unit,
wherein the backup roller is disposed to support at least one of an upper region or a lower region of the forming region.

12. The apparatus for manufacturing a secondary battery according to claim 1, further comprising:
a first rotation jig configured to support one side of an outer surface of the battery case while the first pressing force is applied, thereby rotating the battery case; and
a second rotation jig configured to support one side of an inner surface of the battery case while the second pressing force is applied, thereby rotating the battery case.

13. An apparatus for manufacturing a secondary battery configured to form a beading part in a battery case of the secondary battery, the apparatus comprising:
a first mold, at least a portion of which is disposed inside the battery case and configured to press a forming region of a side wall of the battery case to deform it so as to protrude radially outward; and
a second mold configured to press the forming region, which has been deformed to protrude radially outward by the first mold, so as to be recessed radially inward,
wherein the direction of the pressing force applied by the first mold is opposite to the direction of the pressing force applied by the second mold.

14. A method for manufacturing a secondary battery comprising:
a first forming step of applying a first pressing force in a first direction to a forming region of a battery case; and
a second forming step of applying a second pressing force in a second direction opposite to the first direction to the forming region that has been deformed by the first pressing force.

15. The method for manufacturing a secondary battery according to claim 14, wherein the first direction is a direction away from a central axis of the battery case.

16. The method for manufacturing a secondary battery according to claim 14, wherein the second pressing force is smaller than the first pressing force.

17. The method for manufacturing a secondary battery according to claim 14, wherein the forming region is formed axially above an electrode assembly accommodated inside the battery case.

18. The method for manufacturing a secondary battery according to claim 14, wherein in the first forming step, the forming region is deformed to protrude radially outward of the battery case by the first pressing force, and
in the second forming step, the forming region is deformed to be recessed radially inward of the battery case by the second pressing force.

19. The method for manufacturing a secondary battery according to claim 14, further comprising, after completion of the first forming step, a mold unit moving step of moving a mold unit that has performed the first forming step to a position for performing the second forming step.

20. The method for manufacturing a secondary battery according to claim 14, wherein the second forming step is performed after deformation of at least a portion of the forming region has begun.
